(19) United States
(12) Patent Application Publication
(10) Pub. No.: US 2026/0202679 A1
(43) Pub. Date: Jul. 16, 2026

(54) POLARIZATION ROTATING DEVICE

(71) Applicant: TEKNOLOGIAN TUTKIMUSKESKUS VTT OY, Espoo (FI)

(72) Inventors: Matteo CHERCHI, Espoo (FI); Mikko HARJANNE, Espoo (FI)

(21) Appl. No.: 19/157,564

(22) PCT Filed: Feb. 15, 2024
(86) PCT No.: PCT/FI2024/050059

§ 371 Date: Aug. 18, 2025

(30) Foreign Application Priority Data
Feb. 21, 2023 (FI) 20235214

(51) Int. Cl. G02B 27/28; G02B 6/10; G02B 6/12; G02B 6/122; G02B 6/125; G02B 6/126; G02B 6/136; G02B 6/14

(52) U.S. Cl. CPC G02B 27/286; G02B 6/105; G02B 6/1228; G02B 6/125; G02B 6/126; G02B 6/136; G02B 6/14; G02B 2006/12061; G02B 2006/1209

(57) ABSTRACT

A polarization rotating device, comprising a waveguide formed of a crystalline material layer, the waveguide comprising:
an input portion,
a first mode evolution portion to receive TM polarized light from the input portion, and to transform the received TM polarized light into light of a tilted polarization mode by mode evolution,
a second mode evolution portion to receive the light of the tilted polarization mode from the first mode evolution portion, and to transform the received the light of the tilted polarization mode into TE polarized light by mode evolution,
an output portion to output the TE polarized light received from the second mode evolution portion,
wherein the first mode evolution portion comprises a first tapered inclined facet, which widens up, and which defines polygonal cross-sectional shapes together with horizontal and vertical surfaces of the first mode evolution portion,
wherein the second mode evolution portion comprises a second tapered inclined facet, which narrows down, and which defines polygonal cross-sectional shapes together with horizontal and vertical surfaces of the second mode evolution portion,
wherein the expanding tapered inclined facet and the converging tapered inclined facet are portions of the same inclined crystal plane of the crystalline material layer.

### CROSS-REFERENCE TO RELATED APPLICATIONS

This application is a national phase entry of International Application No. PCT/FI2024/050059, filed Feb. 15, 2024, which claims priority to Finland Patent Application Serial No. FI 20235214, filed Feb. 21, 2023, the entire disclosures of which are hereby incorporated herein by reference in their entirety.

### FIELD

The present invention relates to converting polarization state of light.

### BACKGROUND

It is known that a twisted single mode waveguide may be arranged to operate as an adiabatic mode evolution rotator. However, the twisted waveguide typically needs to be long, e.g. longer than 10000 μm. If one wants to provide an adiabatic mode evolution rotator which preserves single mode condition by using a micron-scale waveguide, then the lateral index contrast must typically be low, resulting in an impractically long polarization rotating device. A twisted low index contrast waveguide typically needs a long polarization transition region in order to prevent the light from radiating away from the waveguide, because of the weaker confinement. In the similar manner, a twisted multimode high index contrast micron-scale waveguide also needs a long polarization transition region in order to reduce or avoid coupling to higher order modes.

### SUMMARY

An object is to provide a polarization rotating device. An object is to provide a method for converting polarization state of light. An object is to provide a method for producing a polarization rotating device.

According to an aspect, there is provided a polarization rotating device (500), comprising a waveguide (WG1) formed of a crystalline material layer (MAT1), the waveguide (WG1) comprising:
an input portion (IN1),
a first mode evolution portion (TAP1) to receive TM polarized light from the input portion (IN1), and to transform the received TM polarized light into light of a tilted polarization mode (EVO) by mode evolution,
a second mode evolution portion (TAP2) to receive the light of the tilted polarization mode (EVO) from the first mode evolution portion (TAP1), and to transform the received light of the tilted polarization mode (EVO) into TE polarized light by mode evolution,
an output portion (OUT1) to output the TE polarized light received from the second mode evolution portion (TAP2),
wherein the first mode evolution portion (TAP1) comprises a first tapered inclined facet (FA1), which defines polygonal cross-sectional shapes together with horizontal and vertical surfaces (TOP1, BOT1, SRF1A, SRF1B) of the first mode evolution portion (TAP1), wherein the width of the first tapered inclined facet (FA1) increases with increasing distance from the input portion (IN1),
wherein the second mode evolution portion (TAP2) comprises a second tapered inclined facet (FA2), which defines polygonal cross-sectional shapes together with horizontal and vertical surfaces (TOP1, BOT1, SRF2A, SRF2B) of the second mode evolution portion (TAP2), wherein the width of the second tapered inclined facet (FA2) decreases with increasing distance from the input portion (IN1), wherein the expanding tapered inclined facet (FA1) and the converging tapered inclined facet (FA2) are portions of the same inclined crystal plane (FACE1) of the crystalline material layer (MAT1).

The scope of protection sought for various embodiments of the invention is set out by the independent claims. The embodiments, if any, described in this specification that do not fall under the scope of the independent claims are to be interpreted as examples useful for understanding various embodiments of the invention.

The polarization rotating device may provide polarization conversion in micron-scale waveguides based on mode evolution. The device is based on mode transition from a narrow waveguiding portion to a wide waveguiding portion via asymmetric slanted waveguiding portions. The narrow waveguiding input portion may receive e.g. TM polarized light, and the wide waveguiding output portion may provide TE polarized light as the output. The transition is provided by intermediate slanted waveguiding portions, which comprise expanding and contracting inclined tapered facets formed from a natural 54.7° inclined crystal plane of crystalline silicon. The inclined tapered facets may be easily and accurately produced by wet etching. The inclined tapered facets may enable gradual evolution from TM polarized light into TE polarized light, or vice versa.

Thanks to using the natural inclined facet, the polarization rotating device may provide sufficient polarization conversion efficiency, even in a situation where the polarization rotating device has been produced with relatively large manufacturing tolerances. The polarization rotating device may provide sufficient polarization conversion efficiency also when the dimensions of the waveguide of the polarization rotating device exhibit significant deviations from nominal optimum values. The possibility to allow relatively large manufacturing tolerances may facilitate producing the polarization rotating device. The possibility to allow relatively large manufacturing tolerances may ensure high fabrication yield.

The polarization rotating device may be formed e.g. from silicon (Si). The polarization rotating device may be implemented e.g. by using a silicon-on-insulator waveguide. The waveguiding portions of the polarization rotating device may be formed from crystalline silicon by etching.

Both the narrow input waveguide portion and the wide output waveguide portion may support several TE and TM modes. The polarization rotating device 500 may be arranged to allow multimode operation at at least one operating wavelength of the polarization rotating device. Enabling the multimode operation may significantly reduce optical losses of light propagating in the waveguide.

The polarization rotating device may also be formed from another crystalline material, which has a natural inclined lattice plane, which is transparent at the wavelength or wavelength range of the polarized light, and wherein the angle between the natural inclined lattice plane and the bottom surface of the crystalline material is substantially equal to 54.7°. For example, the polarization rotating device may be formed e.g. from indium phosphide (InP), gallium arsenide (GaAs), or from indium gallium arsenide phosphide (InGaAsP). The 54.7° inclined crystal plane is the feature of crystalline materials having a cubic lattice.

The polarization rotating device may be formed from a crystalline material, which has a natural inclined lattice plane, which is transparent at the wavelength or wavelength range of the polarized light, and wherein the angle between the natural inclined lattice plane and the bottom surface of the crystalline material is in the range of 30° to 60°.

The polarization rotating device may allow varying the wavelength (λ_{IN1}) of the input light in a wide spectral range and/or the device may allow operation with a broad linewidth (Δλ_{IN1}) of the input light.

The (narrow) waveguiding input portion may support at least one TE polarized mode, and the (wide) waveguiding output portion may support at least one TM polarized mode. The dimensions of the input portion may be selected such that the cross section of the input portion may support TE polarized modes, in addition to TM polarized modes. The dimensions of the output portion may be selected such that the cross section of the output portion may support at least one TM polarized mode, in addition to TE polarized modes. The same polarization rotating device may also be used to convert TE polarized light into TM polarized light. The polarization rotating device may convert TE polarized light into TM polarized light, and vice versa. The input portion of the device may guide TE polarized light, and the output portion of the device may guide TM polarized light. The inclined tapered facets may enable gradual evolution from TE polarized light into TM polarized light.

### BRIEF DESCRIPTION OF THE DRAWINGS

In the following examples, several variations will be described in more detail with reference to the appended drawings, in which

FIG. 1 shows, by way of example, in a three-dimensional view, a polarization rotating device,

FIG. 2 shows, by way of example, in a top view, the polarization rotating device of FIG. 1,

FIG. 3a shows, by way of example, polarization modes at different longitudinal positions of the polarization rotating device of FIG. 2, when converting TM polarized light into TE polarized light,

FIG. 3b shows, by way of example, polarization modes at different longitudinal positions of the polarization rotating device of FIG. 2, when converting TE polarized light into TM polarized light,

FIG. 3c shows, by way of example, an operating wavelength within a wavelength range where the crystalline material is transparent,

FIG. 4a shows, by way of example, evolution of optical power of the mode MODE₀ at different axial positions of the polarization rotating device, and evolution of optical power of the mode MODE₁ at different axial positions of the polarization rotating device,

FIG. 4b shows, by way of example, relative optical power of the mode MODE₁ at the output of polarization rotating devices, as the function of the length of the inclined surface,

FIG. 4c shows, by way of example, coupling of modes of the input to modes of the output,

FIGS. 5a to 5c show, by way of example, in a three-dimensional view, producing a polarization rotating device by etching,

FIGS. 6a to 6c show, by way of example, in a cross-sectional end view, producing a polarization rotating device by etching,

FIG. 7a shows, by way of example, in a top view, orientation of a first mode evolution portion and orientation of a second mode evolution portion with respect to the upper edge of the inclined facets,

FIG. 7b shows, by way of example, in a top view, orientations of the mode evolution portions with respect to the upper edge of the inclined facets,

FIG. 8a shows, by way of example, in a three-dimensional view, a polarization rotating device,

FIG. 8b shows, by way of example, in a top view, the polarization rotating device of FIG. 8a,

FIG. 8c shows, by way of example, cross-sectional shapes of the waveguiding portions at different axial positions of the polarization rotating device of FIG. 8a, and

FIGS. 9a-9h show, in cross-sectional views, evolution of the polarization mode MODE₁ at different longitudinal positions of the polarization rotating device of FIG. 8a.

### DETAILED DESCRIPTION

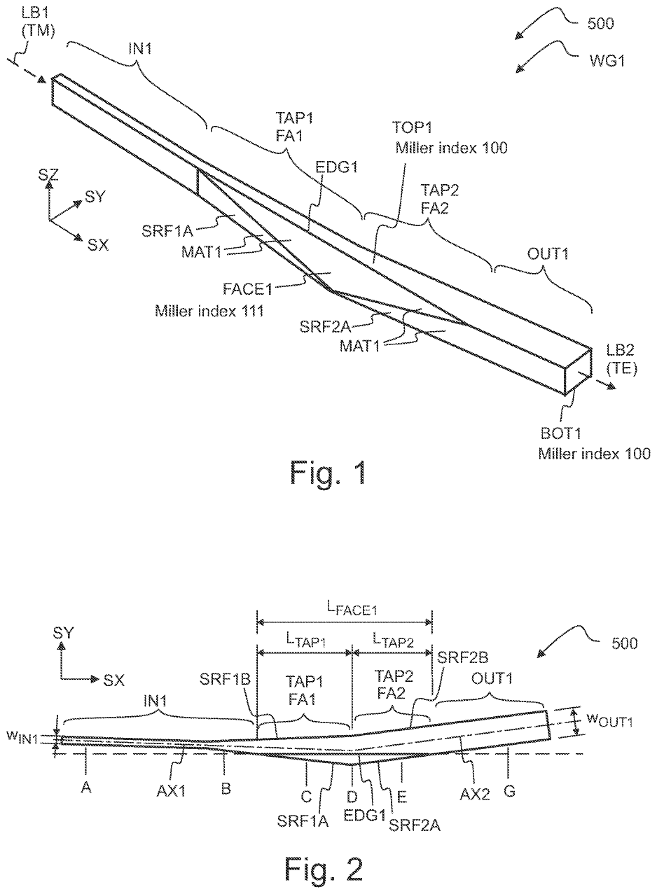

Referring to FIG. 1, the polarization rotating device 500 may transform input light LB1 into output light LB2. For example, the polarization rotating device 500 may transform TM polarized input light LB1 into TE polarized output light LB2.

The polarization rotating device 500 comprises a waveguide WG1, which is formed from a crystalline material layer MAT1. The waveguide WG1 comprises an input portion IN1, a first mode evolution portion TAP1, a second mode evolution portion TAP2, and an output portion OUT1.

The first mode evolution portion TAP1 may receive TM polarized light from the input portion IN1. The first mode evolution portion TAP1 may transform the TM polarized light into light of a tilted polarization mode (EVO) by mode evolution. The second mode evolution portion TAP2 may receive light of the tilted polarization mode (EVO) from the first mode evolution portion TAP1. The second mode evolution portion TAP2 may transform the light of the tilted polarization mode (EVO) into TE polarized light from by mode evolution. The second mode evolution portion TAP2 may provide TE polarized light to an output portion OUT1 of the waveguide WG1. The first mode evolution portion TAP1 may also be called e.g. as a first polarization-rotating portion. The second mode evolution portion TAP2 may also be called e.g. as a second polarization-rotating portion.

The first mode evolution portion TAP1 may receive TM polarized light from the input portion IN1, and the first mode evolution portion TAP1 may transform the light polarization from the TM state into a tilted state through mode evolution.

The second mode evolution portion TAP2 may receive light of the tilted state, and the second mode evolution portion TAP2 may transform the light polarization from the tilted state into TE state through mode evolution.

The first mode evolution portion TAP1 comprises an expanding inclined tapered facet FA1. The second mode evolution portion TAP2 comprises a converging inclined tapered facet FA2. The tapered facets FA1 and FA2 may be portions of the same inclined planar surface FACE1 of the crystalline material MAT1. The orientation (γ1=54.7°) of the inclined surface FACE1 may be defined by a lattice plane of the crystalline material layer MAT1.

The term expanding facet means that the width (d) of the facet (FA1) increases with increasing distance (x) from the input portion (IN1). The expanding tapered inclined facet means a facet, which becomes gradually wider toward the output portion. The expanding tapered inclined facet may also be called as a facet, which widens up.

The term converging facet means that the width of the facet (FA2) decreases with increasing distance (x) from the input portion (IN1). The converging tapered inclined facet means a facet, which becomes gradually narrower toward the output portion. The converging tapered inclined facet may also be called as a facet, which narrows down.

The expanding tapered inclined facet FA1 and the converging tapered inclined facet FA2 may be portions of the same inclined crystal plane FACE1 of the crystalline material layer MAT1. The crystalline material layer MAT1 may have cubic lattice. The inclined planar surface FACE1 may be a lattice plane identified e.g. by the Miller index 111. The top surface TOP1 of the crystalline material layer MAT1 may be a lattice plane identified e.g. by the Miller index 100. The bottom surface BOT1 of the crystalline material layer MAT1 may be a lattice plane identified e.g. by the Miller index 100.

The angle (γ1) between the inclined facets FA1,FA2 and the bottom surface BOT1 may be equal to the angle (54.7°) between a first lattice plane and a second lattice plane of the crystalline material layer MAT1, wherein said first lattice plane is identified by the Miller index 111, and said second lattice plane is identified by the Miller index 100.

To the first approximation, the inclined facet FA1 may be understood to cause conversion of TM polarized light into a tilted mode EVO by promoting electric field components, which are parallel with or orthogonal to said inclined facet FACE1.

The first mode evolution portion TAP1 may be optically coupled to the second mode evolution portion TAP2. The second mode evolution portion TAP2 may adjoin the first mode evolution portion TAP1.

The second mode evolution portion TAP2 comprises a converging tapered portion of the inclined facet FACE1. With increasing distance (x) from the first mode evolution portion, the inclined tapered facet FA2 of the second mode evolution portion TAP2 is gradually replaced with the horizontal top surface (TOP1) of the waveguide WG1, until the cross-sectional shape of the second mode evolution portion is substantially rectangular. The rectangular cross-sectional shape of output end of the second mode evolution portion TAP2 may have a large aspect ratio (AR) e.g. in order to ensure that the mode MODE₀ is TE polarized at the output. To the first approximation, the second mode evolution portion TAP2 may be understood to cause conversion of polarization of the mode MODE₀ by promoting electric fields, which are parallel with the wide top surface TOP1 of the waveguide WG1. The gradual change of the cross-sectional shape and the high aspect ratio may together cause conversion of the tilted polarization mode (EVO) into TE polarized light by mode evolution. The gradual change of the cross-sectional shape and the high aspect ratio may together cause rotation of the tilted polarization mode (EVO), until the electric field of the polarized light is substantially parallel with the top surface TOP1 of the waveguide WG1. The aspect ratio (w_{OUT1}/h_{OUT1}) of the second mode evolution portion TAP2 and/or the output portion OUT1 may be e.g. greater than 1.2. The aspect ratio AR means the ratio (w_{OUT1}/h_{OUT1}) of width (w_{OUT1}) to the height (h_{OUT1}).

The input portion IN1 may have substantially rectangular cross section. The output portion OUT1 may have a substantially rectangular cross section.

The input portion IN1 and/or an input end of the first mode evolution portion TAP1 may have a small aspect ratio (AR), e.g. in order to ensure that the mode MODE₀ is TM polarized in the input portion IN1. The aspect ratio (w_{IN1}/h_{IN1}) means the ratio of the width (w_{IN1}) to the height (h_{IN1}). The aspect ratio of the input portion IN1 may be e.g. smaller than 0.5. The input portion IN1 may adjoin the first mode evolution portion TAP1. The second mode evolution portion TAP2 may adjoin the output portion OUT1. The bottom surface BOT1 of the first mode evolution portion TAP1 may have an expanding tapered shape, so as to gradually increase the width of the waveguide WG1 from the width w_{IN1}of the input portion IN1 to the width w_{OUT1} of the output portion OUT1.

w_{IN1} denotes width of the input portion IN1. h_{IN1} denotes height of the input portion IN1. w_{OUT1} denotes width of the output portion OUT1. h_{OUT1} denotes height of the output portion OUT1. The height h_{IN1} of the input portion IN1 may be equal to the height h_{OUT1} of the output portion OUT1.

The height h_{IN1} of the input portion IN1 may be equal to the height h_{OUT1} of the output portion OUT1, e.g. in order to facilitate production of the device 500. However, the height h_{IN1} of the input portion IN1 may also be different from the height h_{OUT1} of the output portion OUT1.

The aspect ratio of the output portion OUT1 may be greater than the aspect ratio of the input portion IN1, so as to ensure that ensure that the mode MODE₀ is TE polarized in the output portion OUT1.

However, the dimensions of the device 500 may also be selected such that the aspect ratio of the output portion OUT1 is smaller than the aspect ratio of the input portion IN1. The device 500 may enable polarization rotation also if the aspect ratio of the output portion OUT1 is smaller than the aspect ratio of the input portion IN1.

SX, SY and SZ denote orthogonal directions. SX may denote a longitudinal direction of the device 500. SZ may denote a vertical direction. SY may denote a horizontal direction. The light may propagate in the waveguide WG1 substantially in the longitudinal direction SX. The bottom surface BOT1 and the top surface TOP1 of the waveguide WG1 may be parallel with a horizontal plane defined by the directions SX and SY. Vertical side surfaces (SRF1A, SRF1B, SRF2A, SRF2B) of the waveguide WG1 may be perpendicular to the plane defined by the directions SX and SY. The terms “upper” and lower” may be defined with respect to the vertical direction SZ. A coordinate x may indicate a longitudinal position in the direction SX. The light LB1, EVO may propagate substantially in the direction SX.

The same polarization rotating device 500 may also be used to convert TE polarized light into TM polarized light. The first mode evolution portion TAP1 may receive TE polarized input light (LB1) from the input portion IN1. The first mode evolution portion TAP1 may transform TE polarized light of the input portion IN1 into light of a tilted polarization mode (EVO) by mode evolution. The second mode evolution portion TAP2 may receive light of the tilted polarization mode (EVO) from the first mode evolution portion TAP1. The second mode evolution portion TAP2 may transform the light of the tilted polarization mode (EVO) into TM polarized light by mode evolution. The second mode evolution portion TAP2 may provide TM polarized output light (LB2) to an output portion OUT1 of the waveguide WG1.

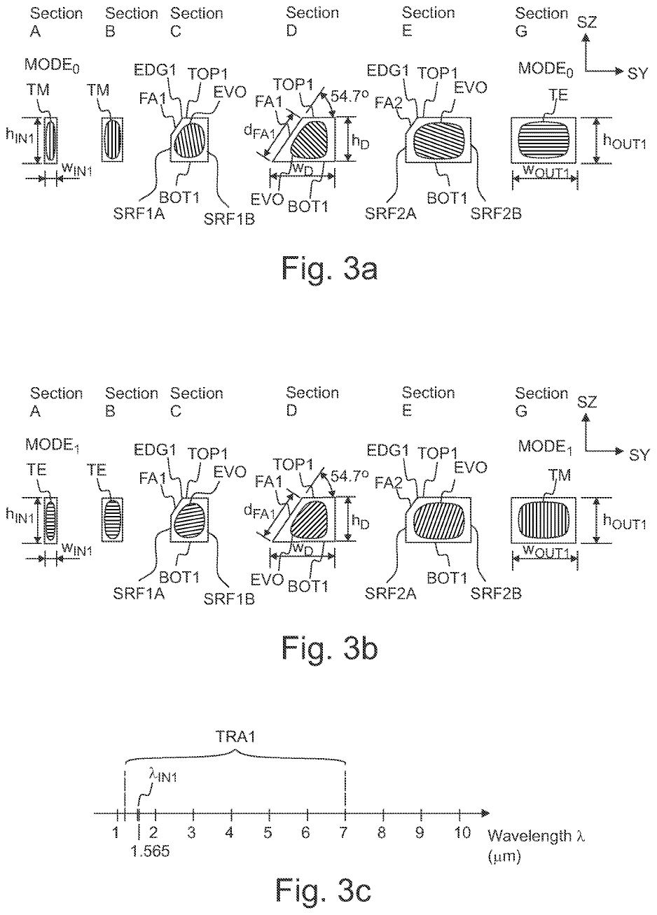

FIG. 2 shows in a top view the polarization rotating device 500. The tapered facet FA1 may be positioned asymmetrically with respect to the centerline (AX1) of the bottom BOT1 of the first mode evolution portion TAP1. The bottom surface BOT1 of the first mode evolution portion TAP1 has expanding tapered shape.

The tapered facet FA2 may be positioned asymmetrically with respect to the centerline (AX2) of the bottom BOT1 of the second mode evolution portion TAP2.

The width WIN1 may be measured in a transverse direction (SY), which is parallel with the top and bottom surfaces TOP1, BOT1. The height h_{IN1}, h_{OUT1} may be measured in a transverse direction (SZ), which is perpendicular to the top and bottom surfaces TOP1, BOT1. The transverse directions (SY, SZ) may be perpendicular to the centerline AX1. The width w_{OUT1} of the output portion OUT1 may be measured in a transverse direction, which is perpendicular to the centerline AX2 and which is perpendicular to the direction SZ.

L_{TAP1} denotes the length of the first tapered inclined facet FA1. L_{TAP2} denotes the length of the second tapered inclined facet FA2. L_{FACE1} denotes the combined length (L_{TAP1}+L_{TAP2}) of the first tapered inclined facet FA1 and the second tapered inclined facet FA2. The combined length (L_{TAP1}+L_{TAP2}) of the tapered inclined facets (FA1, FA2) is in the range of 100 μm to 100 mm. The tapered facets FA1 and FA2 may be portions of the same inclined planar surface FACE1 of the crystalline material MAT1. L_{FACE1} may denote the length of the inclined planar surface FACE1.

L_{TAP1} may also denote the length of the first mode evolution portion TAP1. L_{TAP2} may also denote the length of the second mode evolution portion TAP2. The symbol L_{FACE1} may also denote the combined length of the first mode evolution portion (TAP1) and the second mode evolution portion (TAP2).

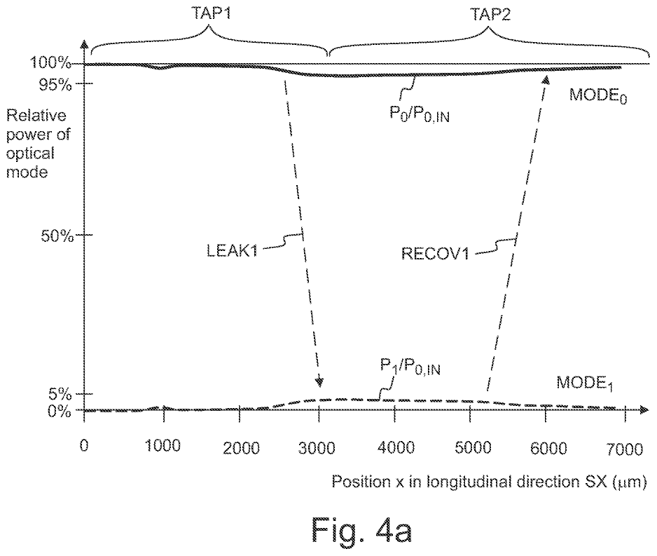

FIG. 3a shows, in a cross-sectional view, a fundamental mode MODE₀ at several different longitudinal positions (A, B, C, D, E, G), in a situation where TM polarized light is converted into TE polarized light. The orientation of the hatch lines in FIG. 3a indicates orientation of the electric field of the fundamental mode MODE₀ at each longitudinal position (A, B, C, D, E, G) of the polarization rotating device 500. The longitudinal positions (A, B, C, D, E, G) are shown also in FIG. 2.

The device 500 may convert the fundamental TM polarized mode MODE₀ of the input cross-section into the fundamental TE polarized mode MODE₀ of the output cross-section. The device 500 may convert the mode MODE₀ of the input cross-section into the mode MODE₀ of the output cross-section.

The symbol MODE₀ denotes the fundamental mode with the highest effective index at a given cross-section. The mode MODE₀ refers to the fundamental mode of a given cross-section with highest effective index, corresponding to either one of the two supported orthogonal polarizations. In other words, the mode MODE₀ refers to the mode, which experiences the highest effective refractive index when propagating in the waveguide.

The term “fundamental mode” refers to a mode, which does not have any nodes. The node is a line where the electric field crosses zero. The term “fundamental mode” may refer to a mode, which has only one intensity maximum (peak) in both transverse directions SY and SZ. Higher order modes which are not “fundamental modes” have two or more intensity maxima (peaks) in one or both transverse directions SY and SZ.

The cross-sectional shape of the first mode evolution portion TAP1 may be a polygon, which has four or five sides. One side of the polygon may be defined by the inclined facet FA1, and the other sides of the polygon may be defined by horizontal and vertical surfaces (TOP1, BOT1, SRF1A, SRF1B) of the waveguide WG1. The expanding tapered inclined facet FA1 defines polygonal cross-sectional shapes together with horizontal and vertical surfaces (TOP1, BOT1, SRF1A, SRF1B) of the first mode evolution portion TAP1.

The cross-sectional shape of the second mode evolution portion TAP2 may be a polygon, which has four or five sides. One side of the polygon may be defined by the inclined facet FA2, and the other sides of the polygon may be defined by horizontal and vertical surfaces (TOP1, BOT1, SRF2A, SRF2B) of the waveguide WG1. The converging tapered inclined facet FA2 defines polygonal cross-sectional shapes together with horizontal and vertical surfaces of the second mode evolution portion TAP2.

The first mode evolution portion TAP1 may transform TM polarized light into light of a tilted polarization mode (EVO) by mode evolution. The second mode evolution portion TAP2 may transform the light of the tilted polarization mode (EVO) into TE polarized light by mode evolution.

To the first approximation, the inclined facet FA1 may contribute to coupling to a tilted high index evolution mode (EVO) by promoting tilted electric fields, which are either parallel with or perpendicular to said inclined facet FA1.

The width WIN1 and the height h_{IN1} of the input portion IN1 may be selected to enable propagation of the TM0 mode of the input light LB1. The width w_{IN1} and the height h_{IN1} may mean the dimensions of the waveguiding core of the waveguide WG1. The width w_{IN1} of the input portion IN1 may be e,g. in the range of 20% to 60% of the height h_{IN1} of the input portion IN1. The height h_{IN1} of the input portion IN1 may be e.g. in the range of 1.5 μm to 4 μm.

WD denotes the (maximum) width of the first mode evolution portion TAP1 at the longitudinal position D. h_{D} denotes the height of the first mode evolution portion at the longitudinal position D. d_{FA1} denotes a maximum transverse dimension of the expanding inclined tapered facet FA1. d_{FA2} may denote a maximum transverse dimension of the converging inclined tapered facet FA2. The facet FA1 may adjoin the facet FA2 so that d_{FA2}=d_{FA1}. The transverse dimension d_{FA1} may be measured along the inclined tapered facet FA1. The transverse dimension d_{FA2} may be measured along the inclined tapered facet FA2.

The maximum width (w_{D}) of the bottom surface BOT1 of the first mode evolution portion TAP1 may be e.g. in the range of 1.0 to 2.0 times the height h_{IN1} of the input portion IN1. If the width (w_{D}) of the first mode evolution portion TAP1 is too large, then the light does not effectively interact with the inclined facet FA1. If the width (w_{D}) of the first mode evolution portion TAP1 is too small, then the light is not effectively confined to the waveguide WG1 and/or the light is reflected backwards.

The taper ratio (d_{FA1}/L_{TAP1}) of the facet FA1 may be e.g. in the range of 1:10000 to 1:1000. The taper ratio (d_{FA2}/L_{TAP2}) of the facet FA2 may be e.g. in the range of 1:10000 to 1:1000. The taper ratio ((w_{D}-w_{IN1})/L_{TAP1}) of the bottom surface BOT1 of the first mode evolution portion TAP1 may be e.g. in the range of 1:10000 to 1:1000.

FIG. 3b shows, in a cross-sectional view, the other fundamental mode MODE₁ at several different longitudinal positions (A, B, C, D, E, G) of the device 500, in a situation where TE polarized light is converted into TM polarized light. The orientation of the hatch lines in FIG. 3b indicates orientation of the electric field of the modes MODE₁ at each longitudinal position (A, B, C, D, E, G).

The polarization rotating device 500 may convert the fundamental TE polarized mode MODE₁ of the input cross-section into the fundamental TM polarized mode MODE₁ of the output cross-section. The symbol MODE₁ denotes the fundamental mode with lowest effective index of a given cross-section. The mode MODE₁ may be called e.g. as a low index mode MODE₁. The device 500 may convert the low index mode MODE₁ of the input cross-section into the low index mode MODE₁ of the output cross section.

Each cross-section (A, B, C, D, E, F, G) of the device 500 may support two fundamental modes (MODE₀, MODE₁) with orthogonal polarization. For example, the input cross-section A may support the fundamental TM polarized high index mode MODE₀ (electric field orientation 90° relative to SY axis in FIG. 3a) and/or a fundamental TE polarized low index mode MODE₁ (electric field orientation 0° in FIG. 3b). For example, the output cross section G may support the fundamental TE polarized high index mode MODE₀ (electric field orientation 0° in FIG. 3 a) and/or the fundamental TM polarized low index mode MODE₁ (electric field orientation 90° in FIG. 3b). The electric field orientation may be specified with respect to the bottom surface BOT1.

Assuming that the material of the waveguide is non-birefringent (e.g. silicon), the mode MODE₀ with the highest effective index value in the narrow waveguide is the fundamental TM polarized mode, whereas the mode MODE₀ with the highest effective index value in the wide waveguide is the fundamental TE polarized mode.

The mode MODE₀ may be e.g. the fundamental TM mode of the input section, one of the tilted (fundamental) modes EVO of an intermediate section, or the fundamental TE polarized mode of the output section. The TM polarized mode MODE₀ may have the highest effective refractive index in the narrow waveguide section A shown in FIG. 3a, and the TE polarized mode MODE₀ may have the highest effective refractive index in the wide waveguide section G shown in FIG. 3a. The TM polarized fundamental mode is the mode MODE₀ of section A, whereas the TE polarized fundamental mode is the MODE₀ of section G.

The polarization rotator may operate adiabatically or almost adiabatically, by keeping the light in the mode MODE₀ (the one with highest effective index) when launching the mode MODE₀, which results in the polarization rotation.

The mode MODE₁ refers to the fundamental mode with the lowest effective index of a given cross-section. The mode MODE₁ refers to the fundamental mode whose polarization is orthogonal to the mode MODE₀, which has the highest effective refractive index. In other words, the mode MODE₁ is the fundamental mode for the orthogonal polarization. The mode MODE₁ may be e.g. the fundamental TE polarized mode, the tilted (fundamental) mode EVO or the fundamental TM polarized mode. Both the mode MODE₀ and the mode MODE₁ are fundamental modes, i.e. modes with the highest effective index amongst the modes which have the same polarization. The mode MODE₀ is the mode with overall highest effective index whereas the mode MODE₁ is the fundamental mode with lowest effective index.

The polarization of a mode means the orientation of the main component of the electric field. In general, the sections A and G may support e.g. tens of higher order modes with either TE or TM polarization that have lower effective index than the mode MODE₁. In general, all waveguide modes may have non-zero electric field component in all directions SX, SY, SZ, but one of the components has much higher amplitude compared to the other two.

The TE polarization may be called e.g. as the horizontal polarization (e.g. in the direction SY), and the TM polarization may be called e.g. as the vertical polarization (e.g. in the direction SZ). The orientation of the lines in FIGS. 3a and 3b show the orientation of the main component of the electric field. The TE polarized fundamental mode is the mode MODE₁ of section A, whereas the TM polarized fundamental mode is the mode MODE₁ of section G. The polarization rotating device may convert light of the fundamental TE mode of the input cross-section into light of the fundamental TM mode of the output cross-section. The polarization rotating device may convert the light of the mode MODE₁ of the input cross section into light of the mode MODE₁ of the output cross section.

Both the narrow input waveguide portion and the wide output waveguide portion may support several TE and TM modes. The polarization rotating device 500 may be arranged to allow multimode operation at at least one operating wavelength λ_{IN1} of the polarization rotating device 500. An optical method may comprise e.g. receiving TE polarized light, and converting the TE polarized light into TM polarized light by using the polarization rotating device 500 at the operating wavelength λ_{IN1}.

Enabling the multimode operation may reduce optical losses of light propagating in the polarization rotating device 500. The multimode operation may facilitate providing a shortcut to adiabatic operation, which in turn may allow reduced length of the polarization rotating device 500.

The dimensions and the materials of the polarization rotating device 500 may be selected so that the polarization rotating device 500 enables multimode operation at at least one operating wavelength λ_{IN1} of the polarization rotating device 500. The operating wavelength λ_{IN1} refers to a wavelength where the polarization rotating device 500 is capable of operating. The operating wavelength λ_{IN1} may also be called e.g. as a design wavelength.

The at least one operating wavelength λ_{IN1} is in a spectral range TRA1 where the crystalline material MAT1 is transparent. Referring to FIG. 3c, the operating wavelength λ_{IN1} may be selected e.g. from the range of 1.2 μm to 7 μm. The crystalline material MAT1 may be e.g. silicon, and the operating wavelength λ_{IN1} may be selected e.g. from the range of 1.2 μm to 7 μm.

A criterion for enabling multimode operation of the device 500 may be e.g. that the minimum width and the minimum height of the waveguiding core of the waveguide WG1 are greater than 3·λ_{IN1}/(2·n₁), advantageously greater than 5·λ_{IN1}/(2·n₁), and preferably greater than 10·λ_{IN1}/(2·n₁). The symbol n₁ denotes the refractive index of the waveguiding core of the waveguide WG1. The criterion >3·λ_{IN1}/(2·n₁) may be simplified into the form >1.5·λ_{IN1}/n₁.

The width and the height of the input portion IN1 may represent the smallest transverse dimensions of the waveguide WG1. A criterion for enabling multimode operation of the device 500 at the operating wavelength (λ_{IN1}) may be e.g. that the width (w_{IN1}) and the height (h_{IN1}) of the waveguide WG1 are greater than 1.5 times the operating wavelength (λ_{IN1}) divided by the refractive index (n₁) of the crystalline material layer MAT1. In an embodiment, the width (w_{IN1}) and the height (h_{IN1}) may be selected to fulfil the criterion >5·λ_{IN1}/(2·n₁), or even the criterion >10·λ_{IN1}/(2·n₁).

The minimum width and the minimum height of the waveguiding core of the waveguide WG1 may be selected such that the device 500 operates over a subset of the transparency range TRA1. For example, the dimensions of the polarization rotating device 500 may be selected to enable multimode operation in one of the following spectral bands: 1.25 μm to 1.35 μm, 1.47 μm to 1.60 μm, 1.530 μm to 1.565 μm, 2.9 μm to 3.1 μm.

An operating wavelength λ_{IN1} may be e.g. 1.565 μm. For example, the dimensions and the materials of the polarization rotating device 500 may be selected so that the polarization rotating device 500 enables multimode operation at least in the wavelength range of 1.530 μm to 1.565 μm.

For example, the input portion IN1 may have a rectangular cross section, the output portion OUT1 may have a rectangular cross section, the aspect ratio (w_{IN1}/h_{IN1}) of the input portion IN1 may be in the range of 0.2 to 0.5, the aspect ratio (w_{OUT1}/h_{OUT1}) of the output portion OUT1 may be in the range of 1.2 to 5, and the height (h_{IN1}) of the input portion IN1 may be in the range of 1.5 μm to 4 μm, wherein the device 500 may enable multimode operation at least in the wavelength range of 1.530 μm to 1.565 μm.

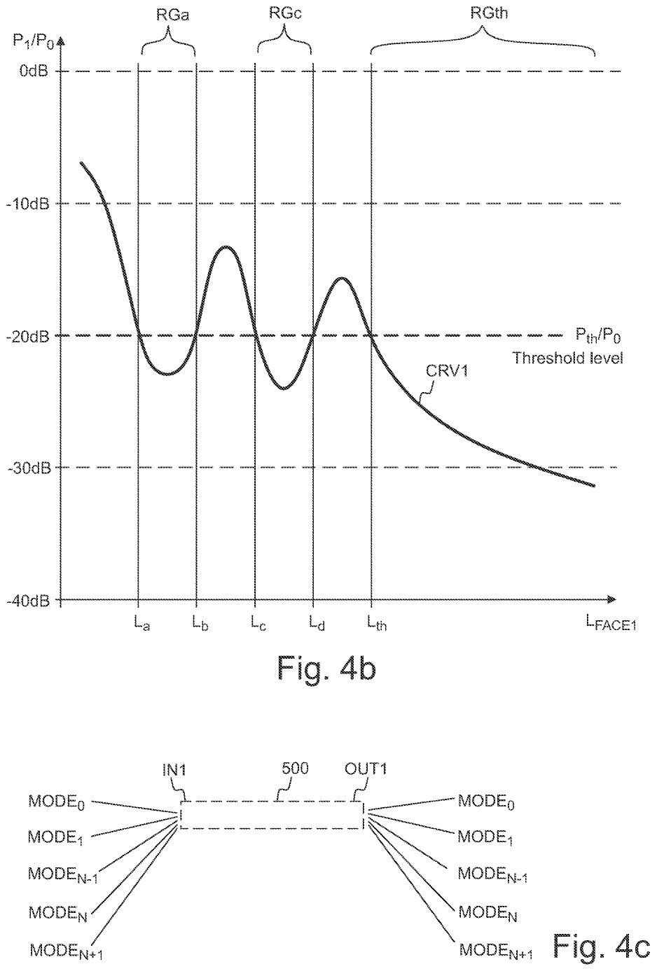

FIG. 4a shows converting TM polarized light into TE polarized light. In this example, 100% of the power is in the TM polarized mode MODE₀ at the input IN1, and 0% of the power is in the TE polarized mode MODE₁ at the input IN1. The upper curve of FIG. 4a shows evolution of relative power of the mode MODE₀ at different longitudinal positions (x) of the polarization rotating device 500. The lower curve of FIG. 4a shows the corresponding evolution of power of the mode MODE₁ at different longitudinal positions (x) of the polarization rotating device 500, as a fraction of power is coupled from the mode MODE₀ to the mode MODE₁, and subsequently back from the mode MODE₁ back to the mode MODE₀. P₀ denotes the power of the mode MODE₀. P₁ denotes the power of the mode MODE₁. P_{0,IN} denotes the initial power of the mode MODE₀ at the input portion IN1.

Both modes MODE₀, MODE₁ may evolve continuously and keep orthogonal to each other at each single cross section. The transformation may be continuous without any leap. The mode MODE₀ of a first cross section may be coupled to the mode MODE₀ of a second cross section. The mode MODE₁ of the first cross section may be coupled to the mode MODE₁ of the second cross section. The polarization rotating device 500 may convert TM polarized input light (LB1) into TE polarized output light (LB2) such that the optical power stays in the mode MODE₀.

The polarization rotating device 500 may operate as an adiabatic device, or as a nearly adiabatic device.

The relative power of the high refractive index mode MODE₀ at the output of the polarization rotating device 500 may be e.g. greater than 99%. When converting TM polarized light into TE polarized light, the relative power P₀/P_{0,IN} of the fundamental (TE) mode MODE₀ at the output of the polarization rotating device 500 may be e.g. greater than 99%.

The polarization rotating device 500 may convert TM polarized input light LB1 into TE polarized output light LB2 such that the residual optical power of TM polarized light at the output OUT1 may be low or zero. For example, the polarization rotating device 500 may convert TM polarized input light LB1 into TE polarized output light LB2 such that the optical power of TM polarized light at the output OUT1 is less than 1% of the optical power of the TM polarized input light LB1.

The polarization rotating device 500 may convert TM polarized input light (LB1) into TE polarized output light (LB2) such that only a small fraction of the power leaks from the high index mode MODE₀ to the low index mode MODE₁.

The dimensions of the first mode evolution portion TAP1 and the dimensions of the second mode evolution portion TAP2 may be selected such that e.g. more than 95% of the power of the polarized light stays in the high refractive index mode MODE₀. The relative power of the mode MODE₁ may remain e.g. less than 5% at all longitudinal positions x of the device, respectively.

The optical power of the high index fundamental mode MODE₀ may also leak (LEAK1) to the low index fundamental mode MODE₁, wherein the dimensions of the portions TAP1, TAP2 may be selected such that a significant fraction of optical power of the low refractive index mode MODE₁ is recovered (RECOV1) back to the high refractive index mode MODE₀.

FIG. 4a shows converting TM polarized light into TE polarized light by using the polarization rotating device 500. The same polarization rotating device 500 may also convert TE polarized light into TM polarized light (not shown in FIG. 4a). The polarization rotator may rotate the polarization by keeping substantially all power in the mode MODE₁, in a situation where 100% of the power is initially in the TE polarized mode MODE₁.

The curve CRV1 of FIG. 4b shows, by way of example, relative optical power P₁/P₀ of the mode MODE₁ as the function of the length L_{FACE1} of inclined surface FACE1. The relative optical power of the mode MODE₁ means the ratio P₁/P₀, where P₁ denotes the optical power of the mode MODE₁, and P₀ denotes the optical power of the orthogonal mode MODE₀. FIG. 4b shows the relative optical power of the mode MODE₁ in logarithmic dB scale. The level −20 dB means that the ratio P₁/P₀ is equal to 1%. The level −30 dB means that the ratio P₁/P₀ is equal to 0.1%. In case of FIG. 4b, the optical power P₁ and P₀ are measured at the output OUT1 of polarization rotating device(s). The relative optical power P₁/P₀ (curve CRV1) may be determined e.g. by computer simulation, where the length of inclined surface FACE1 is varied by keeping other dimensions of the polarization rotating device(s) constant. Alternatively, the curve CRV1 could be determined experimentally by producing a plurality of polarization rotating devices with inclined surfaces of different lengths, and by measuring the power levels P₁, P₀ at the output.

When the mode MODE₀ is launched at the input, most of the power may be coupled to the mode MODE₀ of the output, but a small fraction of power may also be coupled to the mode MODE₁ of the output. In other words, a small fraction of the power may leak to the mode MODE₁ of the output.

The power coupled to the mode MODE₁ may also oscillate as a function of the length L_{FACE1}. The relative optical power P₁/P₀ of the mode MODE₁ may oscillate as the function of the length L_{FACE1}. For a few ranges of the length L_{FACE1}, the relative power coupled to the mode MODE₁ may be smaller than a threshold value Pₜₕ/P₀. The threshold value Pₜₕ/P₀ may be e.g. 1%. The dimensions of the polarization rotating device may be selected e.g. such that the relative optical power of the mode MODE₁ first increases and then decreases with increasing length L_{FACE1}. The effect of the variation of the length L_{FACE1} may be studied by e.g. computer simulation. A suitable length L_{FACE1} may be selected by using a simulated or experimental curve CRV1. The polarization rotating device 500 may be produced or selected according to the selected length L_{FACE1}.

The level of 1% (−20dB) may be considered to represent a practical threshold level for adiabatic operation. RGa denotes a range between lengths Lₐ and L_{b}. RGc denotes a range between lengths L_{c} and L_{d}. The open range RGth denotes lengths, which are greater than or equal to the length Lₜₕ.

In this example, the polarization rotating device(s) may provide a shortcut to adiabatic operation when the length L_{FACE1} is in the range of Lₐ to L_{b}, in the range of L_{c} to L_{d}, or greater than or equal to Lₜₕ. The length L_{FACE1} may be selected such that L>Lₜₕ, such that Lₐ<L_{FACE1}<L_{b}, or L_{c}<L_{FACE1}<L_{d}.

The polarization rotating device 500 may provide adiabatic operation when the length L_{FACE1} is greater than or equal to Lₜₕ, i.e. when the length L_{FACE1} is in the open-ended range RGth. However, selecting the length L_{FACE1} from the open-ended range RGth may provide a rather long polarization rotating device 500. For certain applications, it may be advantageous to use a shorter polarization rotating device 500. Selecting the length L_{FACE1} from the shorter range RGa or RGc may allow providing a shorter polarization rotating device 500, which provides a shortcut to adiabatic operation. The oscillation of the optical power P₁ of the mode MODE₁ may provide a shortcut to adiabatic operation.

The length L_{FACE1} of the inclined surface FACE1 of the polarization rotating device 500 may be selected such that the relative optical power of the mode MODE₁ is smaller than 1% at the output OUT1.

Adiabatic operation may be provided when the length L_{FACE1} of the inclined surface FACE1 is greater than the threshold length Lₜₕ.

A special case of adiabatic operation may be provided when the length L_{FACE1} of the inclined surface FACE1 is in the range RGa, RGc, which corresponds to the local minimum of the optical power of the mode MODE₁ at the output OUT1, in a situation where the optical power P₁ of the mode MODE₁ oscillates as a function of the length L_{FACE1}. The power curve CRV1 may define one or more ranges ranges RGa, RGc, which may provide a shortcut to adiabatic operation.

The shortcuts to adiabaticity, i.e. the local minima RGa, RGc may e.g. allow reducing total length of the polarization rotating device 500. The oscillations of the curve CRV1 illustrate that some significant power fraction may escape into the mode MODE₁, but the escaped power may then be coupled back to the mode MODE₀, e.g. when the length L_{FACE1} is in the range RGc.

Dimensions (e.g. L_{TAP1}, L_{TAP2}, h_{D}, w_{D}, d_{FA1}) of the polarization rotating device 500 may be selected e.g. such that at least 95% of power of TM polarized light of the mode MODE₀ received to the input portion IN1 is coupled to the power of the TE polarized mode MODE₀ at the output portion OUT1.

Dimensions (e.g. L_{TAP1}, L_{TAP2}, h_{D}, w_{D}, D_{FA1}) of the polarization rotating device 500 may be selected e.g. such that at least 99% of power of TM polarized light of the mode MODE₀ received to the input portion IN1 is coupled to the power of the TE polarized mode MODE₀ at the output portion OUT1. In particular, the dimensions may be selected such that at least 99% of the power of the TM polarized light at an operating wavelength λ_{IN1} may be coupled to the power of the TE polarized mode MODE₀ at the output portion OUT1

A suitable length L_{FACE1} may be determined e.g. by simulations, such that different power fractions coupled to the mode MODE₁ in different cross-sections cancel out, leaving most of the power in the mode MODE₀. A fraction of the power may escape from the mode MODE₀ to the mode MODE₁, but the length L_{FACE1} may be selected such most of the escaped power returns back to the mode MODE₀ before the output portion OUT1.

FIG. 4c illustrates, by way of example, coupling of one or more modes (MODE₀, MODE₁, MODE_{N-1}, MODE_{N}, MODE_{N+1}) of the input IN1 to corresponding modes (MODE₀, MODE₁, MODE_{N-1}, MODE_{N}, MODE_{N+1}) of the output OUT1 in the polarization rotating device 500.

Conversions may happen also from higher order TE and TM polarized modes of the input portion IN1 to higher order TM and TE polarized modes of the output portion OUT1. More precisely, a mode MODE_{N} of the input cross-section may be converted to the corresponding mode MODE_{N} of the output cross-section. When the mode MODE_{N} is launched at the input waveguide, then most of the optical power is coupled to the mode MODE_{N} of each section A, B, C, D, E and G, thanks to adiabatic mode evolution.

The symbol MODE_{N} denotes the guided mode of any polarization that has effective index lower than a mode MODE_{N-1} and higher than a mode MODE_{N+1}. N is a number, which identifies a mode. N may be e.g. a positive integer or zero. The higher is the number N, the smaller is the effective index of the mode. Higher order modes have smaller effective indices. The higher the order of the mode, the lower is the associated effective (refractive) index.

A mode is, by definition, a property of each waveguide cross section. Each waveguide cross section may support a certain number of modes. Coupling a mode of a first cross section to a mode of a second different cross section may excite many different modes of the second cross section, especially if the shape of the second cross section is very different from the shape of the first cross section and if the transition is too fast. Slow change from the shape of the first cross section to the shape of the second cross section may ensure that a mode MODE_{N} of the first cross section excites only or mainly the corresponding mode MODE_{N} of the second cross section.

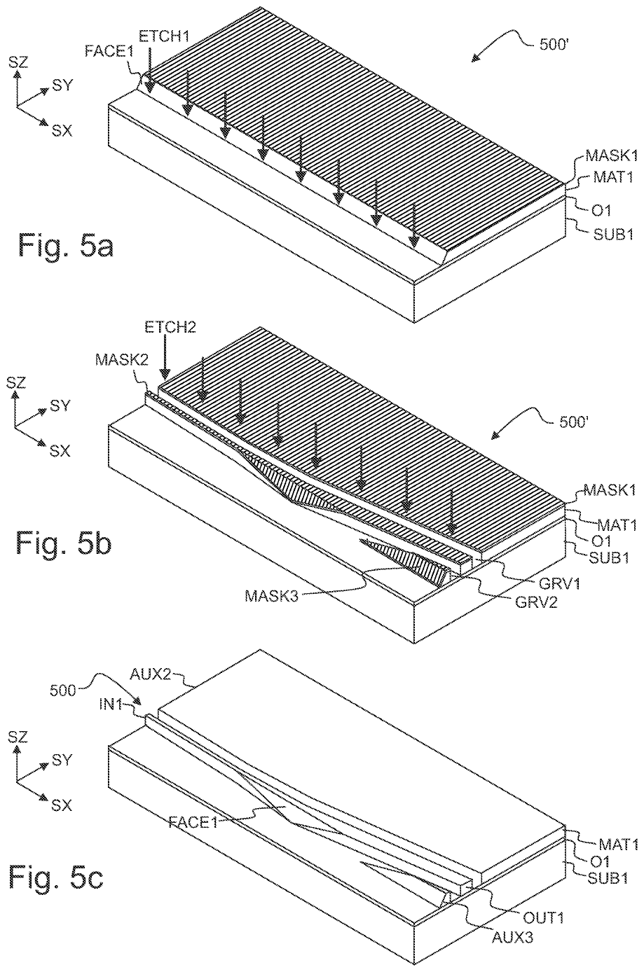

Referring to FIGS. 5a to 5c, the polarization rotating device 500 may be produced from a crystalline material layer MAT1 by etching.

Referring to FIG. 5a, the top surface of the crystalline material layer MAT1 may be covered with an etching mask MASK1. The inclined facet FACE1 may be formed by first etching ETCH1. In particular, the inclined facet FACE1 may be formed by anisotropic wet etching ETCH1.

The wet etching comprises removing material from a crystalline material layer (MAT1) by one or more liquid substances. The liquid substances may be called as etchants. For wet anisotropic etching of silicon, the etchant may be e.g. an aqueous solution of ethylene diamine and pyrocatechol (EDP). For wet anisotropic etching of silicon, the etchant may comprise e.g. tetramethylammonium hydroxide (TMAH). For wet anisotropic etching of silicon, the etchant may comprise e.g. potassium hydroxide (KOH). The etchant may be selected to provide a higher etch rate in the crystal direction <100> when compared with the etch rate in the crystal direction <111>. The crystal direction <100> is perpendicular to the crystal plane specified by the miller index 100. The crystal direction <111> is perpendicular to the crystal plane specified by the miller index 111. An etching stop layer, if used, may consist e.g. of silica or silicon nitride (Si₃N₄).

The symbol 500′ denotes a semi-manufactured polarization rotating device.

The polarization rotating device 500 may be implemented on a substrate SUB1. The polarization rotating device 500 may be formed from a crystalline material layer MAT1, which is supported on a planar substrate SUB1 or on a planar intermediate layer O1.

The substrate SUB1 may comprise e.g. silicon (Si) and/or silica (SiO₂). The waveguide WG1 may be formed e.g. on top of an intermediate layer O1. The intermediate material layer O1 may be located between the crystalline material layer MAT1 and the substrate SUB1. The intermediate layer may be e.g. a silica layer (SiO₂). The intermediate layer O1 may be e.g. a buried oxide layer. The intermediate layer O1 may e.g. comprise or consist of silicon oxide or sapphire. The intermediate layer O1 may be used as an etching stop during the first etching ETCH1 and/or during the second etch ETCH2.

The material layer MAT1 may be e.g. silicon (Si). The device 500 may be fabricated e.g. by using silicon-on-insulator technology. The device 500 may be fabricated e.g. by silicon-on-insulator technology and/or by using complementary metal oxide semiconductor technology.

Alternatively, the material layer MAT1 may be e.g. indium phosphide (InP), gallium arsenide (GaAs), or indium gallium arsenide phosphide (InGaAsP).

The material layer MAT1 may be a multi-layer combination of InP, GaAs, and/or InGaAsP.

Referring to FIG. 5b, at least a part of the top surface of the material layer MAT1 and at least a part of the inclined facet FACE1 may be covered with one or more etching masks MASK1, MASK2. The one or more etching masks MASK1, MASK2 may be patterned according to the shape of the polarization rotating device 500. The vertical surfaces (SRF1A, SRF1B, SRF2A, SRF2B) of the polarization rotating device 500 may be formed by etching ETCH2. The etching ETCH2 may define the shape of the expanding tapered inclined portion FA1 and the shape of the converging tapered inclined portion FA2. The etching ETCH2 may form one or more grooves GRV1, GRV2 by locally removing material from the material layer MAT1 from regions defined by etching mask or masks MASK2, MASK3.

Referring to FIG. 5c the etching masks MASK1, MASK2, MASK3 may be optionally removed.

The waveguiding core (WG1) of the polarization rotating device 500 may be optionally covered with one or more cladding layers. The one or more cladding layers may e.g. protect the waveguiding core (WG1). The refractive index of the cladding layer may be lower than the refractive index of the crystalline material layer MAT1 of the waveguiding core (WG1), so as to enable total internal reflection.

In an embodiment, one or more additional structures AUX2, AUX3 may optionally remain on the intermediate material layer O1 (or on the substrate) after the polarization rotating device 500 has been produced. The structures AUX2, AUX3 may e.g. provide some functionality and/or residual structures AUX2, AUX3 may be allowed to remain attached to the device in order to reduce the amount of material which needs to be removed by the etching (ETCH2).

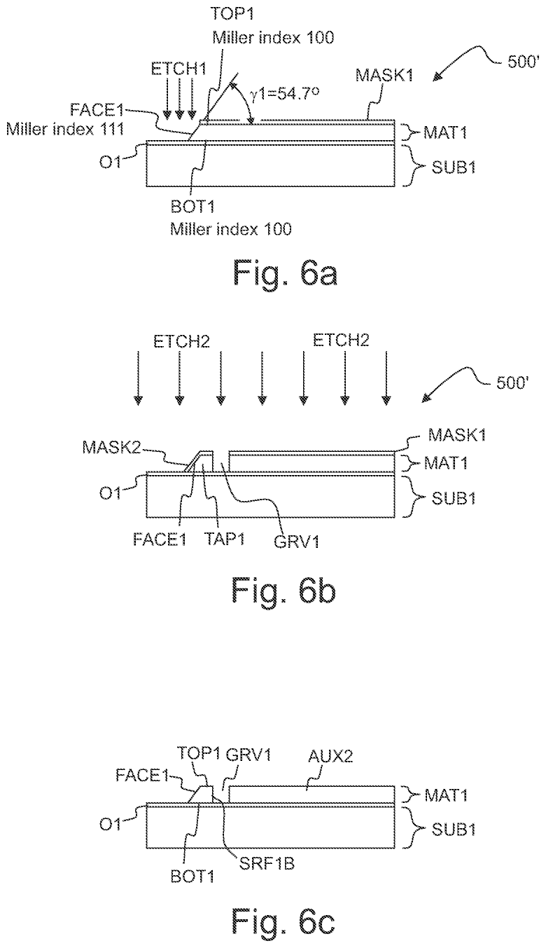

FIG. 6a to 6c show, in a cross-sectional view, forming the polarization rotating device 500.

Referring to FIG. 6a, the top surface of the crystalline material layer MAT1 may be covered with an etching mask MASK1, and the inclined facet FACE1 may subsequently be formed by first etching ETCH1.

Referring to FIG. 6b, at least a part of the inclined facet FACE1 may be covered with an etching mask MASK2. One or more etching masks MASK1, MASK2 may be patterned according to the shape of the polarization rotating device 500. The vertical surfaces (SRF1A, SRF1B, SRF2A, SRF2B) of the polarization rotating device 500 may be formed by etching ETCH2, by using the one or more patterned etching masks MASK1, MASK2. The etching ETCH2 may define the shapes of the tapered facets FA1, FA2. The etching ETCH2 may form one or more grooves GRV1 by removing material from the crystalline material layer MAT1.

Referring to FIG. 6c, the masks may be optionally removed. The crystalline material MAT1 of the polarization rotating device 500 may be optionally covered with a cladding layer.

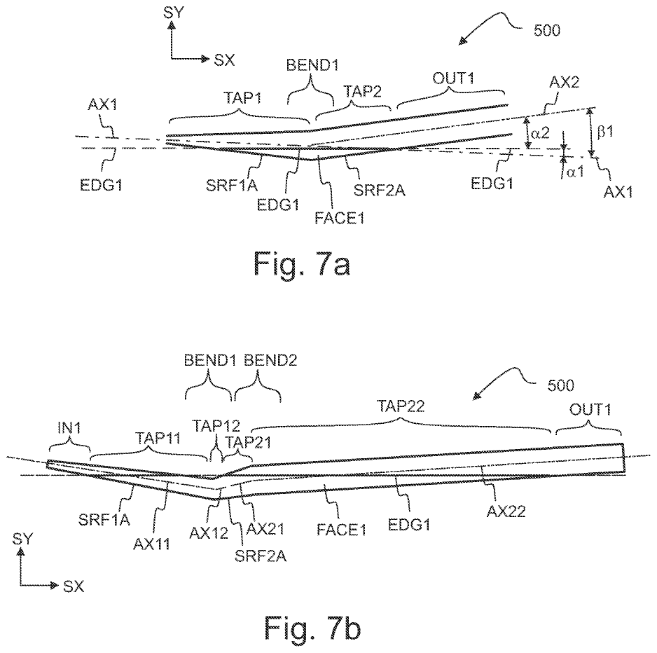

Referring to FIG. 7a, the polarization rotating device 500 may comprise a bend BEND1 between the first mode evolution portion TAP1 and the second mode evolution portion TAP2, so that the inclined facets FA1, FA2 may be implemented as regions of the waveguide WG1.

The bend BEND1 provides a lateral displacement of the vertical surfaces SRF1A, SRF2A with respect to the upper edge EDG1 of the facets FA1, FA2. The bend BEND1 may make it possible to implement the inclined tapered facets FA1, FA2 as portions of the same inclined planar facet FACE1 of the material layer MAT1.

The bottom BOT1 of the first mode evolution portion TAP1 may have a center line AX1, and the bottom BOT1 of the second mode evolution portion TAP2 may have a center line AX2.

α1 may denote an angle between the center line AX1 and the edge EDG1. α2 may denote an angle between the center line AX2 and the edge EDG1. β1 may denote an angle between the directions of the center lines AX1, AX2. The angle α1 may be e.g. in the range of 0.02° to 0.1°. The angle α2 may be e.g. in the range of 0.02° to 0.1°. The angle β1 may be e.g. in the range of 0.02° to 0.1°. The angle α2=0.02° means that the second mode evolution portion TAP2 of length 3000 μm may be displaced in the transverse horizontal direction SY by a distance, which is approximately equal to 1 μm. The displacement of 1 μm may be sufficient to replace the inclined facet FA2 with the vertical side wall SRF2A.

Referring to FIG. 7b, the first mode evolution portion TAP1 may comprise one or more sections TAP11, TAP12. The second mode evolution portion TAP2 may comprise one or more sections TAP21, TAP22.

The first mode evolution portion TAP1 may comprise two or more adjoining sections TAP11, TAP12. The second mode evolution portion TAP2 may comprise two or more adjoining sections TAP21, TAP22.

For example, the direction of the centerline AX11 of the bottom BOT1 of a first section TAP11 may be different from the direction of the centerline AX12 of the bottom BOT1 of a second section TAP12. The device 500 may have a bend BEND1 between the first section TAP11 and the second section TAP12. For example, the direction of the centerline AX21 of the bottom BOT1 of a first section TAP21 may be different from the direction of the centerline AX22 of the bottom BOT1 of a second section TAP22. The device 500 may have a bend BEND2 between the first section TAP21 and the second section TAP22. The sections TAP11, TAP12 may also be called e.g. as (sub-) portions of the first mode evolution portion TAP1. The sections TAP21, TAP22 may also be called e.g. as (sub-) portions of the second mode evolution portion TAP2.

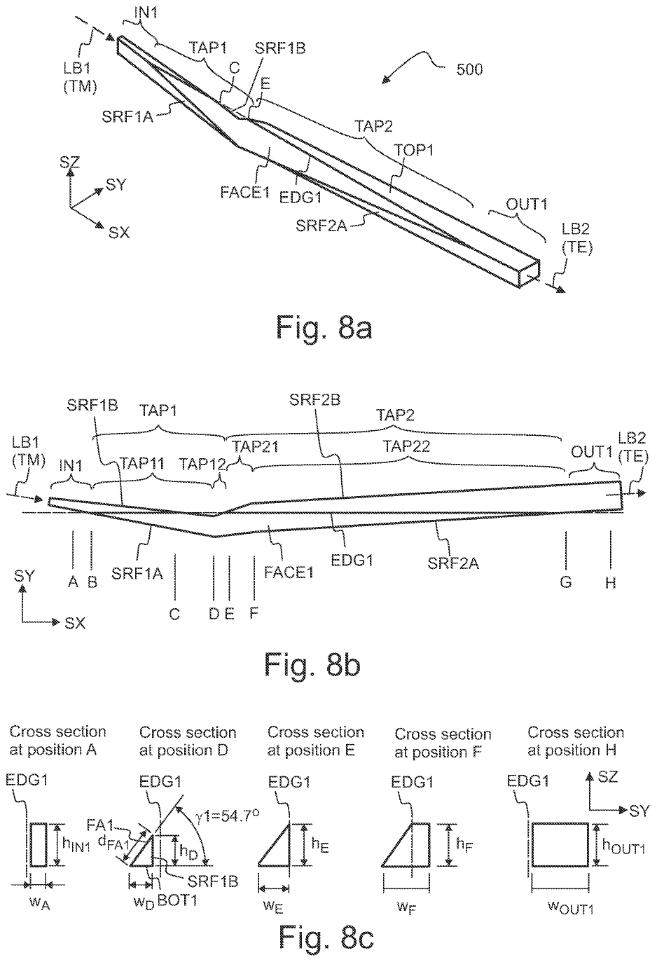

Referring to FIGS. 8a to 8c, the vertical side surface SRF1B of the first mode evolution portion TAP1 may cross the original position of the edge EDG1 of the inclined facet FA1 (FACE1) such that the height (h_{D}) of the mode evolution portion TAP1 at a longitudinal position D may be smaller than the maximum height (h_{IN1}) of the first mode evolution portion TAP1.

The maximum ratio of the transverse dimension (d_{FA1}) of the expanding facet FA1 to the local height (h_{D}) may be equal to 1/sin(γ1). The maximum ratio of the transverse dimension (d_{FA1}) of the expanding facet FA1 to the local height (h_{D}) may be equal to 1/sin(54.7°)=1.225.

FIG. 8a shows, in a three-dimensional view, a polarization rotating device 500, where the vertical side surface SRF1B crosses the original position of the edge EDG1 at the position C and at the position E.

FIG. 8b shows, in a top view, the polarization rotating device 500 of FIG. 8a. FIG. 8b shows longitudinal positions A, B, C, D, E, F, G, H. The vertical surface SRF1B may cross the original position of the edge EDG1 at positions C and E. The vertical surface SRF1A may cross the original position of the edge EDG1 at position B. The vertical surface SRF2A may cross the original position of the edge EDG1 at position G. The waveguide WG1 may have minimum height at position D. Position A may be located at the input portion IN1. Position H may be located at the output portion OUT1.

FIG. 8c shows cross-sections of the waveguide WG1 at several longitudinal positions A, D, E, F, H. The height ho at the longitudinal position D may be smaller than the maximum height h_{IN1}. w_{A}, w_{D}, w_{E}, w_{F} denote the width of the waveguide WG1 at the longitudinal positions A, D, E, F. h_{D}, h_{E}, h_{F} denote the height of the waveguide WG1 at the longitudinal positions D, E, F.

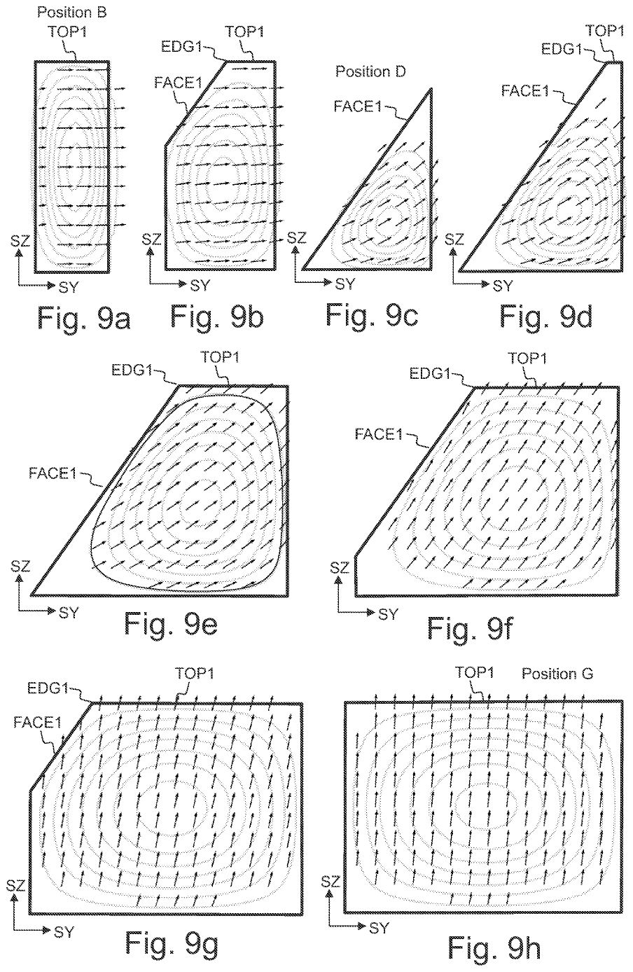

FIG. 9a to 9h show, by way of example, the mode structure at different longitudinal positions of the device 500 of FIG. 8b, in a situation where TE polarized light is converted into TM polarized light. The small arrows indicate the direction of the electric field. The direction of the electric field gradually changes from the horizontal direction (SY) to the vertical direction (SZ) with increasing distance (x) from the input portion IN1.

In general, the polarization rotating device 500 may be used e.g. as a part of a photonic integrated circuit. The device 500 may be used e.g. as a part of a telecommunication system, as a part of an optical measuring apparatus, and/or as a part of a light source. The device 500 may be used e.g. in an optical transmitter or in an optical receiver configured to handle polarization-division-multiplexed (PDM) communication signals.

The spectral operating range of the device 500 may have a minimum wavelength λₘᵢₙ and a maximum wavelength λₘₐₓ. The dimensions of the device 500 may be selected e.g. such that the spectral operating range includes one or more of the following spectral bands: 1.25 μm to 1.35 μm, 1.47 μm to 1.60 μm, 1.530 μm to 1.565 μm, 2.9 μm to 3.1 μm. The device 500 may also be dimensioned to provide a wide spectral operating range. For example, the spectral operating range may comprise the spectral range from 1.2 μm to 4 μm.

The device 500 may form TE polarized light (LB2) from received TM polarized light in a situation where the wavelength λ_{IN1} of the input light LB1 is in the spectral operating range. The wavelength λ_{IN1} of the input light LB1 may be e.g. in the range of 1.2 to 4 μm. The wavelength λ_{IN1} of the input light LB1 may be e.g. substantially equal to 1.55 μm. The wavelength λ_{IN1} of the input light LB1 may be e.g. in the C band, i.e. in the range of 1.530 μm to 1.565 μm. The device 500 may also transform received TM polarized input light LB1 into TE polarized light (LB2) e.g. in a situation where the wavelength λ_{IN1} of the input light LB1 varies between the minimum wavelength λₘᵢₙ and the maximum wavelength λₘₐₓ of the spectral operating range. The device 500 may also receive e.g. multiple spectral components at different wavelengths, in a situation where the multiple spectral components are in the spectral operating range.

TE polarized means that the main component of the electric field of the electromagnetic radiation is perpendicular to the direction of propagation and parallel with the bottom surface BOT1. TM polarized means that the main component of the electric field of the electromagnetic radiation is perpendicular to the direction of propagation and perpendicular with the bottom surface BOT1. TE polarized light may also be called as “s”-polarized light. TM polarized light may also be called as “p”-polarized light. The TE polarized light may refer to TE0 mode of electromagnetic radiation propagating in a waveguide. The TM polarized light may refer to TM0 mode of electromagnetic radiation propagating in a waveguide.

For the person skilled in the art, it will be clear that modifications and variations of the devices and methods according to the present invention are perceivable. The figures are schematic. The particular embodiments described above with reference to the accompanying drawings are illustrative only and not meant to limit the scope of the invention, which is defined by the appended claims.

1. A polarization rotating device, comprising a waveguide formed of a crystalline material layer, the waveguide comprising:
an input portion,
a first mode evolution portion to receive TM polarized light from the input portion, and to transform the received TM polarized light into light of a tilted polarization mode by mode evolution,
a second mode evolution portion to receive the light of the tilted polarization mode from the first mode evolution portion and to transform the received light of the tilted polarization mode into TE polarized light by mode evolution,
an output portion to output the TE polarized light received from the second mode evolution portion,
wherein the first mode evolution portion comprises a first tapered inclined facet, which defines polygonal cross-sectional shapes together with horizontal and vertical surfaces of the first mode evolution portion, wherein the width of the first tapered inclined facet increases with increasing distance from the input portion, wherein the second mode evolution portion comprises a second tapered inclined facet, which defines polygonal cross-sectional shapes together with horizontal and vertical surfaces of the second mode evolution portion, wherein the width of the second tapered inclined facet decreases with increasing distance from the input portion, wherein the expanding tapered inclined facet and the converging tapered inclined facet are portions of the same inclined crystal plane of the crystalline material layer, wherein the width and the height of the input portion have been selected such that the polarization rotating device enables multimode operation at at least one operating wavelength of the device.

2. The device of claim 1, wherein the width and the height of the input portion are greater than 1.5 times the operating wavelength divided by the refractive index of the crystalline material layer.

3. The device of claim 1, wherein the operating wavelength is in the range of 1.2 μm to 7 μm.

4. The device of claim 1, wherein an angle between the inclined facets and a bottom surface of the waveguide is equal to the angle between a first lattice plane and a second lattice plane of the crystalline material layer, wherein said first lattice plane is identified by the Miller index 111, and said second lattice plane is identified by the Miller index 100.

5. The device claim 1, wherein the crystalline material is silicon, and the angle between the inclined facets and the bottom surface is equal to 54.7°.

6. The device claim 1, wherein a maximum transverse dimension of the expanding tapered inclined facet greater than the maximum height of the crystalline material layer, advantageously greater than 1.2 times the maximum height of the crystalline material layer.

7. The device claim 1, wherein the ratio of the maximum transverse dimension of the expanding tapered inclined facet to the height of the crystalline material layer is greater than 1.0, advantageously greater than 1.2.

8. The device claim 1, wherein an angle between the centerline of the bottom surface of the first mode evolution portion and an upper edge of the expanding tapered inclined facet is in the range of 0.02° to 0.2°.

9. The device claim 1, wherein the height of the input portion is equal to the height of the output portion, wherein the device comprises a bend between the first mode evolution portion and the second mode evolution portion

10. A method, which comprises receiving TM polarized light, and converting the TM polarized light into TE polarized light by using a polarization rotating device an operating wavelength,
the polarization rotating device comprising a waveguide formed of a crystalline material layer,
the waveguide comprising:
an input portion,
a first mode evolution portion to receive TM polarized light from the input portion, and to transform the received TM polarized light into light of a tilted polarization mode by mode evolution,
a second mode evolution portion to receive the light of the tilted polarization mode from the first mode evolution portion, and to transform the received light of the tilted polarization mode into TE polarized light by mode evolution,
an output portion to output the TE polarized light received from the second mode evolution portion,
wherein the first mode evolution portion comprises a first tapered inclined facet, which defines polygonal cross-sectional shapes together with horizontal and vertical surfaces of the first mode evolution portion, wherein the width of the first tapered inclined facet increases with increasing distance from the input portion, wherein the second mode evolution portion comprises a second tapered inclined facet, which defines polygonal cross-sectional shapes together with horizontal and vertical surfaces of the second mode evolution portion, wherein the width of the second tapered inclined facet decreases with increasing distance from the input portion, wherein the expanding tapered inclined facet and the converging tapered inclined facet are portions of the same inclined crystal plane of the crystalline material layer, wherein the width and the height of the input portion have been selected such that the polarization rotating device enables multimode operation at at least one operating wavelength of the device.

11. A method, which comprises receiving TE polarized light, and converting the TE polarized light into TM polarized light by using a polarization rotating device at the operating wavelength.
the polarization rotating device comprising a waveguide formed of a crystalline material layer,
the waveguide comprising:
an input portion,
a first mode evolution portion to receive TM polarized light from the input portion, and to transform the received TM polarized light into light of a tilted polarization mode by mode evolution,
a second mode evolution portion to receive the light of the tilted polarization mode from the first mode evolution portion, and to transform the received light of the tilted polarization mode into TE polarized light by mode evolution,
an output portion to output the TE polarized light received from the second mode evolution portion,
wherein the first mode evolution portion comprises a first tapered inclined facet, which defines polygonal cross-sectional shapes together with horizontal and vertical surfaces of the first mode evolution portion, wherein the width of the first tapered inclined facet increases with increasing distance from the input portion, wherein the second mode evolution portion comprises a second tapered inclined facet, which defines polygonal cross-sectional shapes together with horizontal and vertical surfaces of the second mode evolution portion, wherein the width of the second tapered inclined facet decreases with increasing distance from the input portion, wherein the expanding tapered inclined facet and the converging tapered inclined facet are portions of the same inclined crystal plane of the crystalline material layer, wherein the width and the height of the input portion have been selected such that the polarization rotating device enables multimode operation at at least one operating wavelength of the device.

12. A method for producing a polarization rotating device,
the method comprising:
providing a layer of crystalline material,
forming an inclined facet on the crystalline material by first wet etching such that an angle between the inclined facet and a bottom surface of the layer is equal to 54.7°, and
producing the polarization rotating device from the crystalline material layer by second etching,
the polarization rotating device comprising a waveguide formed of a crystalline material layer,
the waveguide comprising:
an input portion,
a first mode evolution portion to receive TM polarized light from the input portion, and to transform the received TM polarized light into light of a tilted polarization mode by mode evolution,
a second mode evolution portion to receive the light of the tilted polarization mode from the first mode evolution portion, and to transform the received light of the tilted polarization mode into TE polarized light by mode evolution,
an output portion to output the TE polarized light received from the second mode evolution portion,
wherein the first mode evolution portion comprises a first tapered inclined facet, which defines polygonal cross-sectional shapes together with horizontal and vertical surfaces of the first mode evolution portion, wherein the width of the first tapered inclined facet increases with increasing distance from the input portion, wherein the second mode evolution portion comprises a second tapered inclined facet, which defines polygonal cross-sectional shapes together with horizontal and vertical surfaces of the second mode evolution portion, wherein the width of the second tapered inclined facet decreases with increasing distance from the input portion, wherein the expanding tapered inclined facet and the converging tapered inclined facet are portions of the same inclined crystal plane of the crystalline material layer, wherein the width and the height of the input portion have been selected such that the polarization rotating device enables multimode operation at at least one operating wavelength of the device.
